(19) United States
(12) Patent Application Publication
(10) Pub. No.: US 2022/0402023 A1
(43) Pub. Date: Dec. 22, 2022

(54) DROSS ABATEMENT SYSTEM AND METHODS THEREOF

(71) Applicant: XEROX CORPORATION, Norwalk, CT (US)

(72) Inventors: Seemit Praharaj, Webster, NY (US); Jason M. LeFevre, Penfield, NY (US); Douglas K. Herrmann, Webster, NY (US); Chu-Heng Liu, Penfield, NY (US); David Alan VanKouwenberg, Avon, NY (US); Linn C. Hoover, Webster, NY (US)

(73) Assignee: XEROX CORPORATION, Norwalk, CT (US)

(21) Appl. No.: 17/348,908

(22) Filed: Jun. 16, 2021

(51) Int. Cl. B22D 43/00; B33Y 40/00; B33Y 30/00; B22D 23/00; B08B 7/00; B01D 15/20

(52) U.S. Cl. CPC B22D 43/00; B33Y 40/00; B33Y 30/00; B22D 23/003; B08B 7/00; B01D 15/203; B01D 2215/022

(57) ABSTRACT

A dross abatement system for a printer is disclosed. The dross abatement system includes a print head ejector, a pump in communication with the print head ejector having an inner cavity, a first inlet coupled to the inner cavity, a supply of printing material external to the print head ejector, a heating element configured to heat the printing material in the ejector, and a supply of absorbent material external to the print head ejector. A method of abating dross in a metal jetting printer is also disclosed, which includes pausing an operation of the printer, advancing an absorbent material into a melt pool within a nozzle pump reservoir, wherein the melt pool may include a metal printing material, absorbing dross from the metal printing material, removing the absorbent material including the dross, and resuming operation of the metal jetting printer.

### TECHNICAL FIELD

The present teachings relate generally to drop-on-demand (DOD) printing and, more particularly, to a dross abatement system and methods for use within a DOD printer.

### BACKGROUND

A drop-on-demand (DOD) or three-dimensional (3D) printer builds (e.g., prints) a 3D object from a computer-aided design (CAD) model, usually by successively depositing material layer upon layer. A drop drop-on-demand (DOD), particularly one that prints a metal or metal alloy, ejects a small drop of liquid aluminum alloy when a firing pulse is applied. Using this technology, a 3D part can be created from aluminum or another alloy by ejecting a series of drops which bond together to form a continuous part. For example, a first layer may be deposited upon a substrate, and then a second layer may be deposited upon the first layer. One particular type of 3D printer is a magnetohydrodynamic (MHD) printer, which is suitable for jetting liquid metal layer upon layer to form a 3D metallic object. Magnetohydrodynamic refers to the study of the magnetic properties and the behavior of electrically conducting fluids.

In MHD printing, a liquid metal is jetted out through a nozzle of the 3D printer onto a substrate or onto a previously deposited layer of metal. A printhead used in such a printer is a single-nozzle head and includes several internal components within the head which may need periodic replacement. In some instances, a typical period for nozzle replacement may be an 8-hour interval. During the liquid metal printing process, the aluminum and alloys, and in particular, magnesium containing alloys, can form oxides and silicates during the melting process in the interior of the pump. These oxides and silicates are commonly referred to as dross. The buildup of dross is a function of pump throughput and builds continuously during the print process. In addition to being composed of a combination of aluminum and magnesium oxides and silicates, the dross may also include gas bubbles. Consequently, the density of the dross may be lower than that of the liquid metal printing material and builds at the top of the melt pool, eventually causing issues during printing. In addition, dross accumulation impacts the ability of internal level-sensing that measures the molten metal level of the pump. This can cause the pump to erroneously empty during printing, thereby ruining the part. Dross plugs may also grow within the pump causing issues with the pump dynamics resulting in poor jet quality and additional print defects, such as the formation of satellite drops during printing. The dross could potentially break apart and a chunk of this oxide falls into the nozzle resulting in a clogged nozzle. All of the aforementioned failures arising from dross accumulation are catastrophic, leading to printer shut down, requiring clearing or removal of the dross plug, replacing the print nozzle, and beginning start-up procedures again.

Thus, a method of and apparatus for abatement of dross in a metal jet printing drop-on-demand or 3D printer is needed to provide longer printing times and higher throughput without interruption from defects or disadvantages associated with dross build-up.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A dross abatement system for a printer is disclosed. The dross abatement system includes a print head ejector. The dross abatement system also includes a pump in communication with the print head ejector having an inner cavity. The dross abatement system also includes a first inlet coupled to the inner cavity. The dross abatement system also includes a supply of printing material external to the print head ejector. The dross abatement system also includes a heating element configured to heat the printing material in the ejector, thereby causing the printing material to change from a solid state to a liquid state within the ejector. The dross abatement system also includes a supply of absorbent material external to the print head ejector.

Alternate implementations of a dross abatement system may include where the absorbent material may further include a continuous filament. The absorbent material may thermally stable at a temperature above 1000° C. The absorbent material may be inert in contact with the printing material. The absorbent material may be an alkaline earth silicate wool. The absorbent material may include alumino silicate wool. The absorbent material may include polycrystalline wool. The absorbent material may be introduced into the inner cavity via the first inlet. The dross abatement system may include a second inlet coupled to the inner cavity. The absorbent material may be introduced into the inner cavity via the second inlet. The supply of absorbent material further may include a spool.

A method of abating dross in a metal jetting printer is also disclosed. The method of abating dross also includes pausing an operation of the metal jetting printer, advancing an absorbent material into a melt pool within a nozzle pump reservoir, wherein the melt pool may include a metal printing material. The method of abating dross in a metal jetting printer may also include absorbing dross from the metal printing material, removing the absorbent material including the dross from the pump reservoir, and resuming the operation of the metal jetting printer.

The method of abating dross in a metal jetting printer may also include an absorbent material which includes a continuous filament. The absorbent material may further include a mineral wool. The dross may include a silicate or oxide. The method of abating dross in a metal jetting printer may include discarding the absorbent material which includes the dross after the step of removing the absorbent material from the pump reservoir. The method of abating dross in a metal jetting printer may include removing a wire feed of printing material prior to introducing the absorbent material prior to the step of advancing the absorbent material into the pump reservoir. The method of abating dross in a metal jetting printer may include extracting the dross from the absorbent material after the step of removing the absorbent material from the pump reservoir. The method of abating dross in a metal jetting printer may include reusing the absorbent material after the step of removing the absorbent material from the pump reservoir. The method of abating dross in a metal jetting printer may include repeating the preceding steps of the method.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 depicts a schematic cross-sectional view of a single liquid ejector jet of a 3D printer (e.g., a MHD printer and/or multi jet printer), according to an embodiment.

FIG. 2 is a side cross-sectional views of a liquid ejector jet contaminated with dross, according to an embodiment.

FIGS. 3A-3F are a series of side cross-sectional views of a single liquid ejector jet with a dross abatement system, illustrating operative steps of the dross abatement system, according to an embodiment.

FIG. 4 is a flowchart illustrating a method of abating dross in a metal jetting printer, according to an embodiment.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

In drop-on-demand (DOD) or three-dimensional (3D) a small drop of liquid aluminum or other metal or metal alloy are ejected when a firing pulse is applied. Using this printing technology, a 3D part can be created from aluminum or another alloy by ejecting a series of drops which bond together to form a continuous part. During a typical printing operation, the raw printing material wire feed can be replenished to the pump inside an ejector using a continuous roll of aluminum wire. The wire printing material may be fed into the pump using standard welding wire feed equipment or other means of introduction, such as a powder feed system. As printing occurs and new material is fed into the pump, a contaminant known as dross may accumulate in the top of the upper pump of the ejector. This build-up of dross is a function of the total throughput of printing material through the pump and ejector. As the dross contamination builds within the pump and/or ejector it eventually results in defects such as degraded jetting performance, nozzle or machine contamination, level sensor faults, additional printer maintenance, shut down, or contamination related catastrophic failure. While systems exist to counteract dross accumulation in similar ejector and printer systems, they are fairly complex and require manual operations involving multiple operators.

Disclosed herein is a system and method including the use of a high temperature stable absorbent material, such as a mineral wool, that is used to periodically absorb and consequently remove the dross from the top of the melt pool within an ejector or pump in a 3D printing system. For the purposes of this disclosure, absorbent material may refer to any fibrous material primarily made from spinning or drawing a molten mineral or other rock materials into fibers or continuous fiber filaments. Exemplary examples of high temperature absorbent material or more specifically, mineral wool, may be stable up to 1000° C. and are capable of withstanding and accommodating the temperatures in the upper pump required for molten metal jetting, which are typically approximately 800° C. or above, depending on the printing material.

The absorption and removal of the dross may be periodically performed in-situ or within an ejector by incorporating a dross abatement system internally to an ejector or externally to the ejector system during the building of a part. In certain embodiments, the printer may be paused intermittently in order to perform a dross removal operation or procedure. Upon completion of the dross removal operation the pump may be refilled, and the printing operation and thus the part build is resumed. In certain embodiments, the absorbent material may be lowered or introduced into the ejector pump via a dedicated inlet. In other embodiments, the absorbent material may be lowered or introduced into the ejector pump via the same inlet as is currently used to feed the aluminum wire or other printing material.

Once introduced into the ejector pump, the absorbent material may float at the top of the melt pool of printing material in a similar manner as does the accumulated dross, thereby absorbing the dross from the melt pool of printing material. Once the dross is absorbed by the absorbent material, the absorbent material including the dross contamination may be retracted from the ejector pump via the same inlet into which it was previously introduced. The dross-soaked absorbent material or mineral wool may be either discarded, compressed via constriction or pressing to extract and remove the collected dross. Extraction and removal of the dross from the absorbent material after removal from the ejector pump may enable reuse of the absorbent material. Once the dross contaminant has been removed, the printing material may be re-introduced into the ejector pump and the operation of the printer may be resumed.

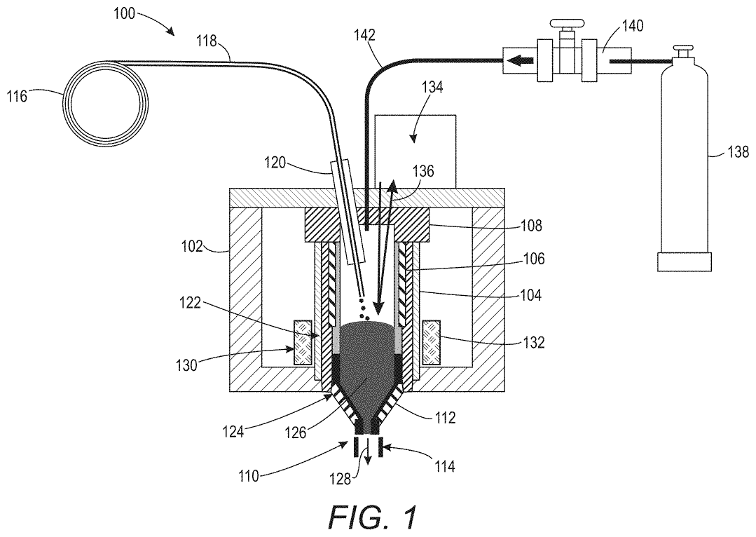

FIG. 1 depicts a schematic cross-sectional view of a single liquid ejector jet of a 3D printer (e.g., a MHD printer and/or multi jet printer), according to an embodiment. FIG. 1 shows a portion of a type of drop-on-demand (DOD) or three-dimensional (3D) printer 100. The 3D printer or liquid ejector jet system 100 may include an ejector (also referred to as a body or pump chamber, or a “one-piece” pump) 104 within an outer ejector housing 102, also referred to as a lower block. The ejector 104 may define an inner volume 132 (also referred to as an internal cavity). A printing material 126 may be introduced into the inner volume 132 of the ejector 104. The printing material 126 may be or include a metal, a polymer, or the like. For example, the printing material 126 may be or include aluminum or aluminum alloy, introduced via a printing material supply 116 or spool of a printing material wire feed 118, in this case, an aluminum wire. The liquid ejector jet system 100 further includes a first inlet 120 within a pump cap or top cover portion 108 of the ejector 104 whereby the printing material wire feed 118 is introduced into the inner volume 132 of the ejector 104. The ejector 104 further defines a nozzle 110, an upper pump 122 area and a lower pump 124 area. One or more heating elements 112 are distributed around the pump chamber 104 to provide an elevated temperature source and maintain the printing material 126 in a molten state during printer operation. The heating elements 112 are configured to heat or melt the printing material wire feed 118, thereby changing the printing material wire feed 118 from a solid state to a liquid state (e.g., printing material 126) within the inner volume 132 of the ejector 104. The three-dimensional 3D printer 100 and ejector 104 may further include an air or argon shield 114 located near the nozzle 110, and a water coolant source 130 to further enable nozzle and/or ejector 104 temperature regulation. The liquid ejector jet system 100 further includes a level sensor 134 system which is configured to detect the level of molten printing material 126 inside the inner volume 132 of the ejector 104 by directing a detector beam 136 towards a surface of the printing material 126 inside the ejector 104 and reading the reflected detector beam 136 inside the level sensor 134.

The 3D printer 100 may also include a power source, not shown herein, and one or more metallic coils 106 enclosed in a pump heater that are wrapped at least partially around the ejector 104. The power source may be coupled to the coils 106 and configured to provide an electrical current to the coils 106. An increasing magnetic field caused by the coils 106 may cause an electromotive force within the ejector 104, that in turn causes an induced electrical current in the printing material 126. The magnetic field and the induced electrical current in the printing material 126 may create a radially inward force on the printing material 126, known as a Lorenz force. The Lorenz force creates a pressure at an inlet of a nozzle 110 of the ejector 104. The pressure causes the printing material 126 to be jetted through the nozzle 110 in the form of one or more liquid drops 128.

The 3D printer 100 may also include a substrate, not shown herein, that is positioned proximate to (e.g., below) the nozzle 110. The ejected drops 128 may land on the substrate and solidify to produce a 3D object. The 3D printer 100 may also include a substrate control motor that is configured to move the substrate while the drops 128 are being jetted through the nozzle 110, or during pauses between when the drops 128 are being jetted through the nozzle 110, to cause the 3D object to have the desired shape and size. The substrate control motor may be configured to move the substrate in one dimension (e.g., along an X axis), in two dimensions (e.g., along the X axis and a Y axis), or in three dimensions (e.g., along the X axis, the Y axis, and a Z axis). In another embodiment, the ejector 104 and/or the nozzle 110 may be also or instead be configured to move in one, two, or three dimensions. In other words, the substrate may be moved under a stationary nozzle 110, or the nozzle 110 may be moved above a stationary substrate. In yet another embodiment, there may be relative rotation between the nozzle 110 and the substrate around one or two additional axes, such that there is four or five axis position control. In certain embodiments, both the nozzle 110 and the substrate may move. For example, the substrate may move in X and Y directions, while the nozzle 110 moves up and/or down in a Y direction.

The 3D printer 100 may also include one or more gas-controlling devices, which may be or include a gas source 138. The gas source 138 may be configured to introduce a gas. The gas may be or include an inert gas, such as helium, neon, argon, krypton, and/or xenon. In another embodiment, the gas may be or include nitrogen. The gas may include less than about 10% oxygen, less than about 5% oxygen, or less than about 1% oxygen. In at least one embodiment, the gas may be introduced via a gas line 142 which includes a gas regulator 140 configured to regulate the flow or flow rate of one or more gases introduced into the three-dimensional 3D printer 100 from the gas source 138. For example, the gas may be introduced at a location that is above the nozzle 110 and/or the heating element 112. This may allow the gas (e.g., argon) to form a shroud/sheath around the nozzle 110, the drops 128, the 3D object, and/or the substrate to reduce/prevent the formation of oxide (e.g., aluminum oxide) in the form of an air shield 114. Controlling the temperature of the gas may also or instead help to control (e.g., minimize) the rate that the oxide formation occurs.

The liquid ejector jet system 100 may also include an enclosure 102 that defines an inner volume (also referred to as an atmosphere). In one embodiment, the enclosure 102 may be hermetically sealed. In another embodiment, the enclosure 102 may not be hermetically sealed. In one embodiment, the ejector 104, the heating elements 112, the power source, the coils, the substrate, additional system elements, or a combination thereof may be positioned at least partially within the enclosure 102. In another embodiment, the ejector 104, the heating elements 112, the power source, the coils, the substrate, additional system elements, or a combination thereof may be positioned at least partially outside of the enclosure 102.

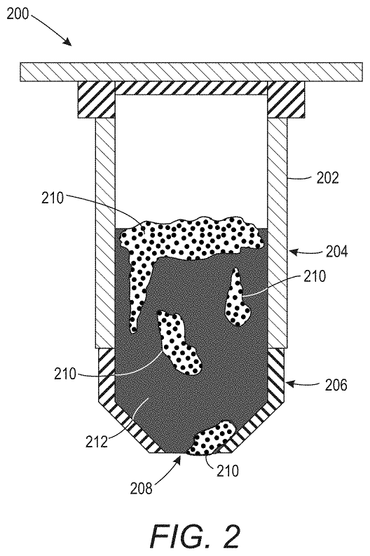

FIG. 2 is a side cross-sectional views of a liquid ejector jet contaminated with dross, according to an embodiment. The ejector 200 is shown, which further defines a cavity or outer wall 202 of the ejector, an upper pump area 204, a lower pump area 206, and an outlet nozzle 208. Within the inner cavity 202 of the ejector 200 is further shown a molten printing material 212 and schematic of dross 210 build-up within and on top of the printing material 212. The dross 210, in certain embodiments, and dependent upon which printing material is used in the printing system, is a combination of aluminum oxides, magnesium oxides, and silicates. The dross 210 may also include gas bubbles. In certain embodiments, the dross 210, may include additional materials or contaminants, such as oxides and silicates of aluminum (Al), calcium (Ca), magnesium (Mg), silicon (Si), iron (Fe), or possibly other contaminants containing sodium (Na), potassium (K), sulfur (S), chlorine (Cl), carbon (C) or combinations thereof, The dross 210 typically builds towards the top of the melt pool that resides near the upper pump area 204 in the ejector 200 and may potentially cause issues during printing. Dross 210 accumulation may potentially impact the ability of the aforementioned level sensor that measures the molten metal level inside the ejector 200. An erroneous signal for the level sensor system can cause the pump to empty during printing, which could result in ruining the part being printed. One or more dross 210 “plugs” may also have a propensity to grow within the pump, which in turn may cause issues with the pump dynamics. Interruptions or issues in pump dynamics may further result in poor jet quality and the formation of satellite drops during printing. A satellite drop may refer to a drop with only a fraction of the volume of the main drop which can be unintentionally formed during the jetting of a main drop. For example, a physical occlusion at the nozzle is one potential cause resulting in the formation of a satellite drop. In certain embodiments or instances, the dross 210 could also potentially break apart, and a portion of this fragmented dross or oxide may fall into the nozzle 208 resulting in a clogged nozzle 208. Any failure arising from the accumulation of dross 210 has the tendency to be catastrophic, which could lead to necessitating a shut down of the printer, having to clear or remove the dross 210 plug, replacing the print nozzle, beginning start-up again, or combinations thereof.

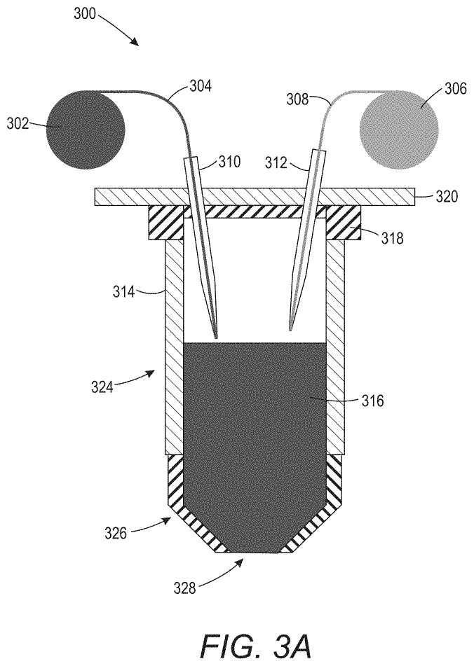

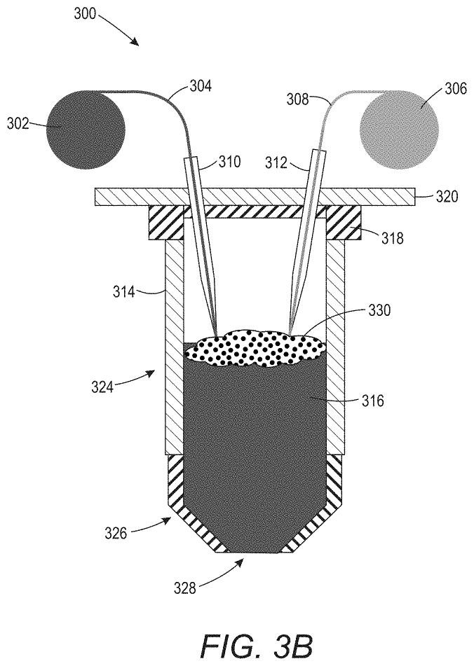

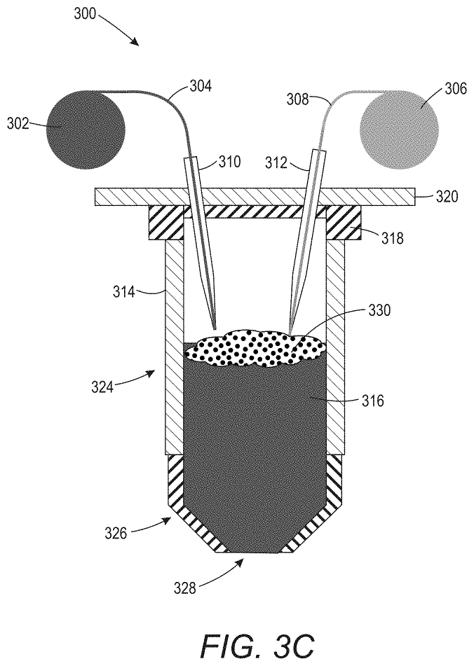

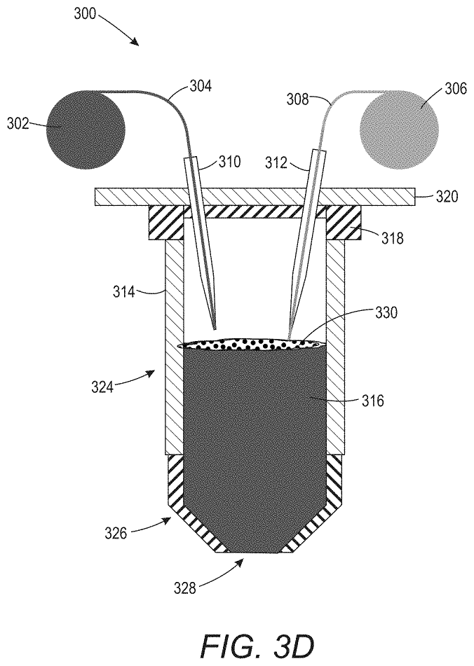

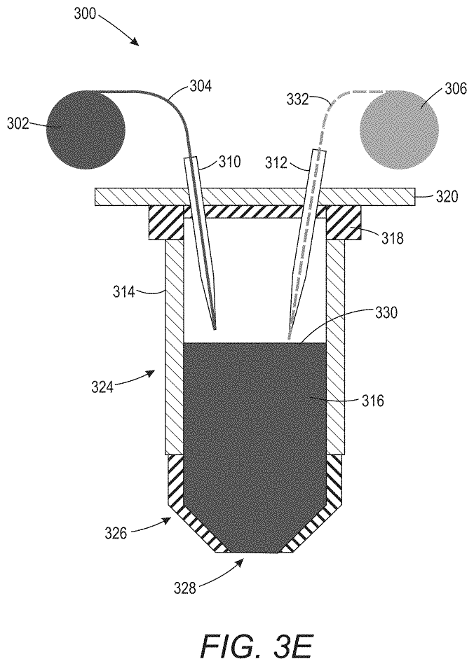

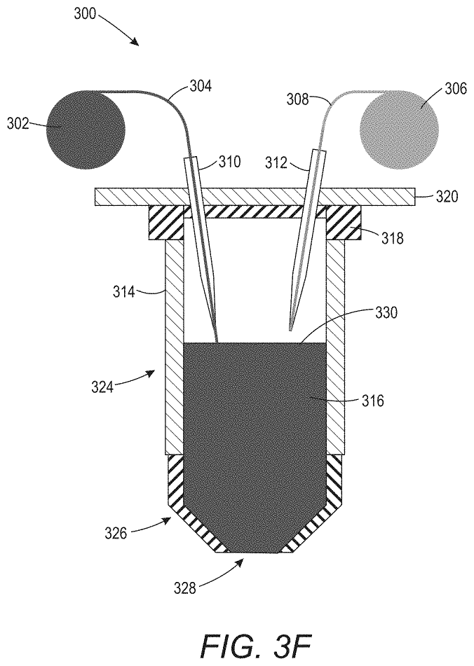

FIGS. 3A-3F are a series of side cross-sectional views of a single liquid ejector jet with a dross abatement system, illustrating operative steps of the dross abatement system, according to an embodiment. FIG. 3A is a side cross-sectional view of a print head ejector or single liquid ejector jet, similar to the one illustrated in FIG. 1, with a dross abatement system, according to an embodiment. A liquid ejector jet with a dross abatement system 300 is shown, having a printing material supply 302 with a wire feed of printing material 304 shown external to an ejector 314. Certain embodiments may have the printing material supply 302 located internal to a housing that includes the ejector 314. Furthermore, alternate embodiments may include other means of introduction of printing material, such as a powder feed system or other printing material introduction means known to those skilled in the art. Example printing materials which could be ejected using a liquid ejector according to embodiments described herein also include alloys of aluminum, copper, iron, nickel, brasses, naval brass, and bronzes. Silver and alloys thereof, copper and alloys thereof, metallic alloys, braze alloys, or combinations thereof may also be printed using liquid ejectors according to embodiments herein.

The liquid ejector jet with a dross abatement system 300 further includes an absorbent material supply 306 which is a spool containing a continuous filament of absorbent material 308. Certain embodiments may have the absorbent material supply 306 located internal to the ejector 314 housing. Furthermore, alternate embodiments may include other means of introduction of absorbent material, such as a manual absorbent material introduction means known to those skilled in the art. Absorbent materials that are suitable for such high temperature applications such as those described herein include materials that are thermally stable at temperatures from about 850° C. to about 1600° C., chemically and physically inert in contact with printing materials, or fabricated from materials having low density or high surface area. Suitable absorbent materials include fibrous materials known generically as mineral wools, which may be fabricated from different types of minerals. Example mineral wools which may be used as absorbent materials in a dross abatement system include alkaline earth silicate wool (AES wool), alumino silicate wool (ASW), polycrystalline wool (PCW), kaowool, or combinations thereof. AES wool is made from amorphous glass fibers that are produced by melting a calcium oxide, magnesium oxide, and silicon dioxide, among other materials. Alumino silicate wool, which may also be referred to as refractory ceramic fiber (RCF), is made from amorphous fibers produced by melting aluminum oxide and silicon dioxide. Polycrystalline wool is made from aluminum oxide fibers in a sol-gel aqueous spinning method, followed by crystallization at elevated temperature. Kaowool is made from the mineral kaolin. In some instances, the absorbent materials are made via a spinning process wherein continuous or segmented fibers are fabricated by spinning molten rock or minerals with high-speed spinning heads, resulting in fine, intertwined fibers. Some mineral wools may also include binder materials, polymers, oils, or combinations thereof in their compositions.

The ejector jet with a dross abatement system 300 of FIG. 3A also includes a first inlet 310 and a second inlet 312 at the top cover of the liquid ejector jet housing 320. The first inlet 310 and second inlet 312 allow access to the ejector cavity 314 for both the printing material 304 and the absorbent material 308, respectively. The ejector jet with a dross abatement system 300 is in communication with and further defines a top portion 318 of the liquid ejector jet 300 an upper pump area 324, a lower pump area 326, and a nozzle 328. Within the ejector jet with a dross abatement system 300 is shown a quantity of molten printing material 316. FIG. 3B illustrates a cross-sectional schematic of the ejector jet with a dross abatement system 300 having an accumulation of dross 330 inside the ejector cavity 314 of the ejector jet 300. The absorption and removal of the dross may be periodically performed in-situ during the building of a part or other operation of the printing system including the ejector jet with a dross abatement system 300. At a point of sufficient dross 330 accumulation, or during a predetermined service interval, the printer is intermittently paused during to accommodate the dross 330 removal operation.

FIG. 3C illustrates the absorbent material 308 being lowered form the absorbent material supply 306 into the ejector jet 300 via the second inlet 312. The absorbent material supply 306 may be lowered into the pump using either a dedicated inlet 312 as shown or in certain embodiments by the same first inlet 310 that is currently used to feed the aluminum wire printing material 304 from the printing material supply 302. In the case of the first inlet 310 being used to introduce and advance the absorbent material 308, the printing material 304 would be removed prior to the introduction of the absorbent material 308 into the first inlet 310. Once the absorbent material 308 is lowered into the upper pump area 324 as shown in FIG. 3D, the absorbent material 308 floats at the top of the melt pool of molten printing material 316 as does the accumulated dross 330, thereby absorbing the dross 330.

FIG. 3E illustrates a step in the dross abatement showing the dross 330, now absorbed into the absorbent material 308 as an absorbent material including dross 332, the absorbent material 308 or absorbent material including dross 332 is retracted back towards the absorbent material supply 306 and out of the ejector cavity 314 of the ejector jet 300 via the second inlet 312. In certain embodiments, the first inlet 310 that is used to feed the aluminum wire printing material 304 from the printing material supply 302 may be used for advancement and retraction of the absorbent material 308. The dross-soaked absorbent material including dross 332 can either be sectioned, discarded, or alternatively compressed via a means of constriction to extract and remove the collected dross 330 to enable reuse. In certain embodiments, the absorbent material 308 may be reused by removing collected dross with a chemical treatment, such as a strong acid, to remove the dross and reuse the absorbent material 308 in an offline or external procedure at room temperature. In these embodiments, it may be beneficial to isolate these operations away from the pump rather than risk contamination to the ejector or the printing system.

At this stage, the printing material 304 may be fed back into the ejector cavity 314 of the ejector jet 300 and printing operations or part build can be resumed. This stage of being ready to re-use or re-deploy the ejector jet including a dross abatement system and the absorbent material 308 via the absorbent material supply 306 is represented in FIG. 3F. Thus, the dross removal can occur during the part print job and the print job can continue once the dross is removed from the system. It should be noted that alternate embodiments of a dross abatement system for a liquid metal ejector as shown herein may include alternate means of introducing an absorbent material into an ejector jet to remove accumulated dross may be employed as well. This may include manual introduction and removal of an absorbent material into and out from an ejector jet, such by an operator. Introducing and removing absorbent material into an ejector jet to remove accumulated dross may also be accomplished via alternate supply sources such a reels, plungers, multiple spools, bobbins, shuttles, filatures, and other devices known to those skilled in the art.

Advantages of such an in-process dross abatement system include higher printing throughput, reduced downtime for cleaning or catastrophic failures related to dross accumulation, extended print run time, larger part builds, and increased printing system productivity. Additional system advantages include improved jetting performance, improved measurement and control of the level of the melt pool inside the ejector jet, enablement of printing system running at higher pump temperatures for improved jet quality, and improved component life, particularly the life of the upper pump of the ejector.

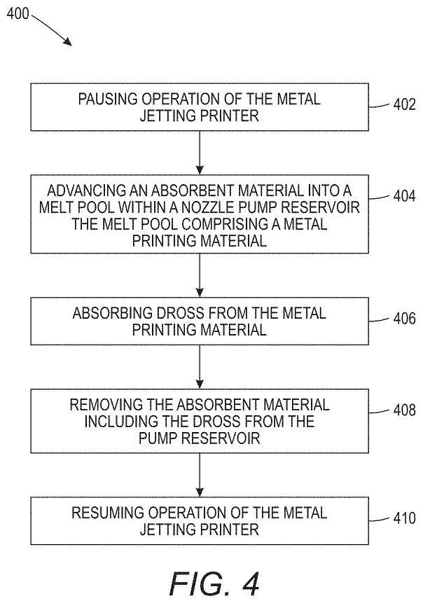

FIG. 4 is a flowchart illustrating a method of abating dross in a metal jetting printer, according to an embodiment. A method of abating dross in a metal jetting printer 400 is illustrated, which includes a step of pausing an operation of the metal jetting printer 402. While a metal jetting printer, or MEM drop-on-demand printer is printing, or the printer is in progress with respect to a normal printing operation, the printer may be paused. In certain embodiments, this pausing may be executed manually or automatically, either at a pre-determined operation interval or initiated by an external factor, such as a level sensor detecting an interrupted or anomalous reading, an observed printing defect, an inefficient jetting operation, or other atypical reading within the metal jetting printing system. Next, the method of dross abatement 400 includes advancing an absorbent material into a melt pool within a nozzle pump reservoir, the melt pool comprising a metal printing material 404. In certain embodiments, the absorbent material may be advanced into the same inlet or entrance into the liquid ejector into which the printing material is introduced. Therefore, the method of dross abatement 400 may also include removing a wire feed of printing material prior to introducing the absorbent material prior to the step of advancing the absorbent material into the pump reservoir. Exemplary examples of absorbent materials suitable for use in this method have been described previously herein. Certain embodiments of the method of dross abatement 400 may utilize an absorbent material made from a continuous filament. Other embodiments may further include an absorbent material such as a mineral wool. Certain embodiments of the method of dross abatement 400 may include dross material which is made of a silicate or an oxide of the metal or metal alloys included in the printing material.

The method of dross abatement 400 further includes absorbing dross from the metal printing material 406. As the liquid printing material resides in the melt pool, dross accumulation may occur, as described previously. This dross contamination typically resides on the surface of the melt pool, and thus the absorbent material need only be in contact with the molten surface of the melt pool, such that it absorbs the dross material from the remaining liquid or molten metal within the melt pool held in the inner cavity of the pump in the liquid metal ejector. In certain embodiments, the absorbent material may be left to reside at or under the surface of the melt pool for a predetermined length of time in order to absorb a sufficient quantity of dross to prevent detrimental pump and ejector operation. The method of dross abatement 400 includes a subsequent step of removing the absorbent material including the dross from the pump reservoir 408. As shown previously in regard to FIGS. 3A-3F, the supply of absorbent material is removed or retracted from the inner cavity of the pump in the ejector, thereby removing the dross that is absorbed within the absorbent material. In certain embodiments, after removing the absorbent material, which includes the dross, the absorbent material which includes the dross after removing the dross and absorbent material from the ejector pump reservoir is discarded. In other embodiments, the absorbent material which includes the dross after removing the dross and absorbent material from the ejector has the dross extracted from the absorbent material, either by sectioning the absorbent material including the dross, wringing, vacuuming, or otherwise cleaning the dross from the absorbent material. Still other embodiments may include a step of reusing the absorbent material after the step of removing the absorbent material from the pump reservoir. Finally, the method of dross abatement 400 may further include resuming the operation of the metal jetting printer 410. According to certain embodiments, the method of abating dross 400 in a metal jetting printer may further include repeating any or all of the steps of the method as previously described or at any specified interval.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A dross abatement system for a printer, comprising:
a print head ejector;
a pump in communication with the print head ejector having an inner cavity;
a first inlet coupled to the inner cavity;
a supply of printing material external to the print head ejector;
a heating element configured to heat the printing material in the ejector, thereby causing the printing material to change from a solid state to a liquid state within the ejector; and
a supply of absorbent material external to the print head ejector.

2. The dross abatement system of claim 1, wherein the absorbent material further comprises a continuous filament.

3. The dross abatement system of claim 1, wherein the absorbent material is thermally stable at a temperature above 1000° C.

4. The dross abatement system of claim 1, wherein the absorbent material is inert in contact with the printing material.

5. The dross abatement system of claim 1, wherein the absorbent material comprises alkaline earth silicate wool.

6. The dross abatement system of claim 1, wherein the absorbent material comprises alumino silicate wool.

7. The dross abatement system of claim 1, wherein the absorbent material comprises polycrystalline wool.

8. The dross abatement system of claim 1, wherein the absorbent material is introduced into the inner cavity via the first inlet.

9. The dross abatement system of claim 1, further comprising a second inlet coupled to the inner cavity.

10. The dross abatement system of claim 9, wherein the absorbent material is introduced into the inner cavity via the second inlet.

11. The dross abatement system of claim 1, wherein the supply of absorbent material further comprises a spool.

12. A method of abating dross in a metal jetting printer, comprising:
(a) pausing an operation of the metal jetting printer;
(b) advancing an absorbent material into a melt pool within a nozzle pump reservoir, the melt pool comprising a metal printing material;
(c) absorbing dross from the metal printing material;
(d) removing the absorbent material including the dross from the pump reservoir; and
(e) resuming the operation of the metal jetting printer.

13. The method of abating dross in a metal jetting printer of claim 12, wherein the absorbent material further comprises a continuous filament.

14. The method of abating dross in a metal jetting printer of claim 12, wherein the absorbent material further comprises a mineral wool.

15. The method of abating dross in a metal jetting printer of claim 12, wherein the dross comprises a silicate or oxide.

16. The method of abating dross in a metal jetting printer of claim 12, further comprising discarding the absorbent material which includes the dross after the step of removing the absorbent material from the pump reservoir.

17. The method of abating dross in a metal jetting printer of claim 12, further comprising removing a wire feed of printing material prior to introducing the absorbent material prior to the step of advancing the absorbent material into the pump reservoir.

18. The method of abating dross in a metal jetting printer of claim 12, further comprising extracting the dross from the absorbent material after the step of removing the absorbent material from the pump reservoir.

19. The method of abating dross in a metal jetting printer of claim 18, further comprising reusing the absorbent material after the step of removing the absorbent material from the pump reservoir.

20. The method of abating dross in a metal jetting printer of claim 12, further comprising repeating steps (a) through (e).
